(19) United States
(12) Patent Application Publication
(10) Pub. No.: US 2007/0022847 A1
(43) Pub. Date: Feb. 1, 2007

(54) Positioning device for positioning driving member in wrench

(76) Inventor: Terence Chen, Dungshan Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/190,960

(22) Filed: Jul. 28, 2005

(51) Int. Cl. B25B 13/06; B25B 23/16

(52) U.S. Cl. 81/180.1; 81/121.1; 81/177.85

(57) ABSTRACT

A positioning device for hand tools includes a driving member engaged with a hole in a wrench head and a groove is defined in an outer periphery of the driving member so as to receive a C-shaped clip therein. The clip includes an engaging section which is matched with a straight positioning part defined in an inner periphery of the groove so that the clip does not rotate relative to the driving member. The clip further has at least one curve biasing portion which extends out from the groove and is engaged with an inner periphery of the groove to position the driving member in the hole of the wrench head.

### FIELD OF THE INVENTION

The present invention relates to a positioning clip engaged with a groove of a driving member which is rotatably engaged with a wrench head and the clip includes protrusions to be engaged with the inside of the wrench head.

### BACKGROUND OF THE INVENTION

A conventional wrench generally includes a head with a hole defined therethrough and a driving member is rotatably engaged with the hole. A O-ring is mounted to the driving member so as to be in contact with an inside of the hole to position the driving member relative to the wrench head. The O-ring tends to be fragile or loosened after used for a period of time. Some manufacturers use C-clip 90 as shown in FIG. 6, wherein the two distal ends of the clip 90 are engaged with the groove 910 of the driving member 91 and includes at least two shrink portions 900 and at least one protrusion 901. The at least two shrink portions 900 are engaged with the groove 910 and the at least one protrusion 901 protrudes from the groove 910. However, the clip 90 is not firmly positioned and slips when in use.

The present invention intends to provide a positioning device to effectively position the driving member in the wrench head.

### SUMMARY OF THE INVENTION

The present invention relates to a positioning device for positioning the driving member in a hand tool, wherein the driving member includes a groove defined in an outer periphery thereof and an inner periphery defining the groove includes a positing part. A clip is engaged with the groove and has an engaging section which is matched with the positioning part of the groove. The clip has a biasing portion which extends out from the groove.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the positioning device of the present invention;

FIG. 2 shows the clip and the driving member of the positioning device of the present invention;

FIG. 3 is a perspective view to show that the clip is engaged with the groove in the driving member;

FIG. 4 is a top view to show that the engaging section of the clip is matched with the positioning part of the groove;

FIG. 5 shows that the biasing portion of the clip protrudes out from the groove of the driving member to be engaged with an inner periphery of the hole in the wrench head, and

FIG. 6 is a cross sectional view to show the conventional positioning device.

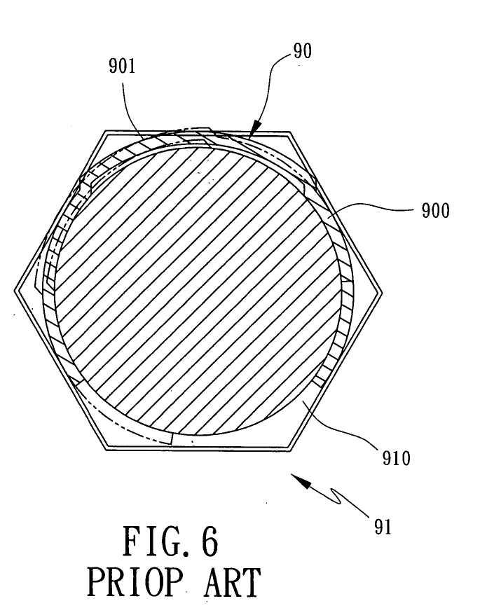

### DETAILED DESCRIPTION OF THE PREFERRED EMBODIMENT

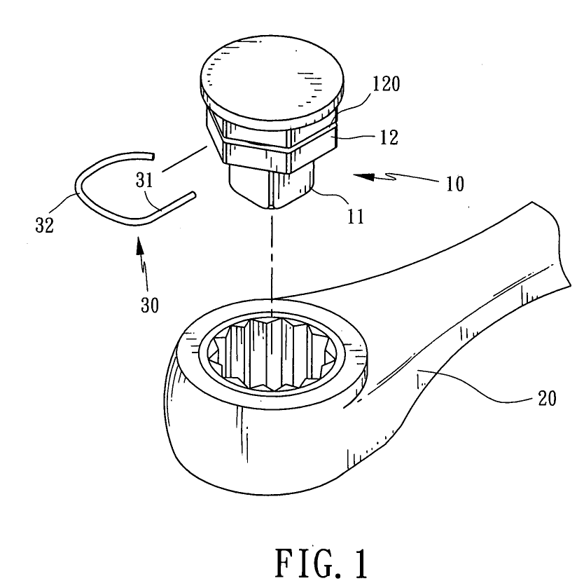

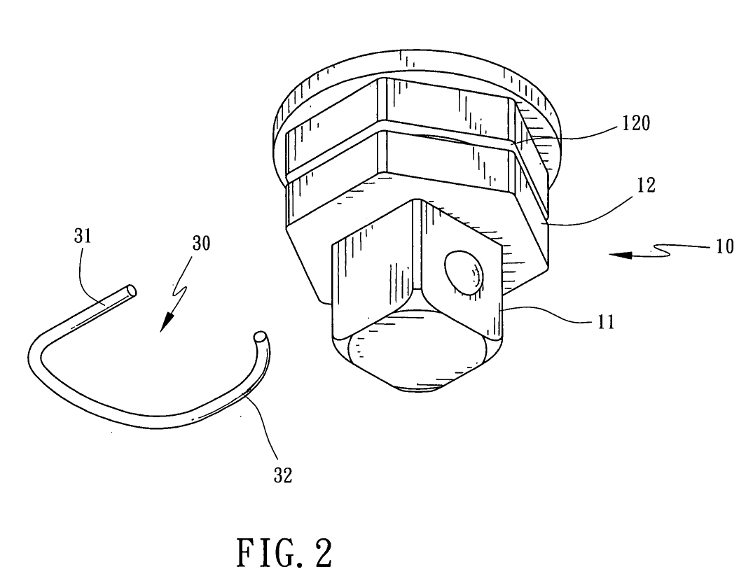

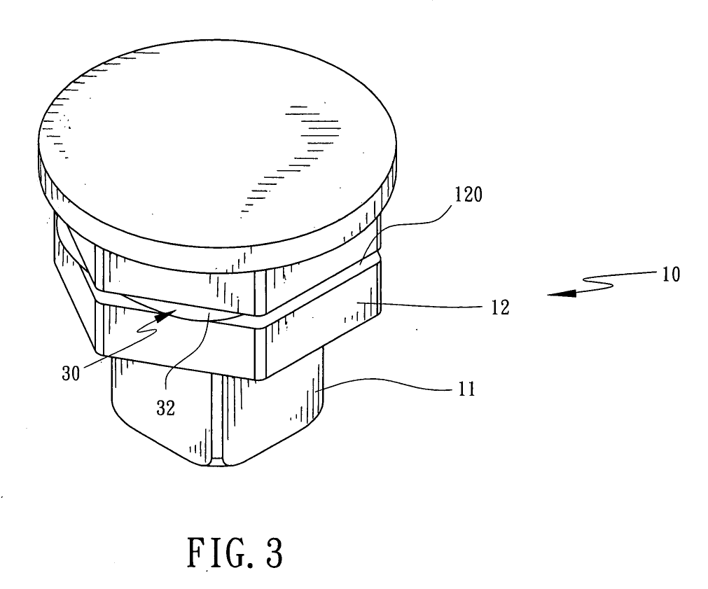

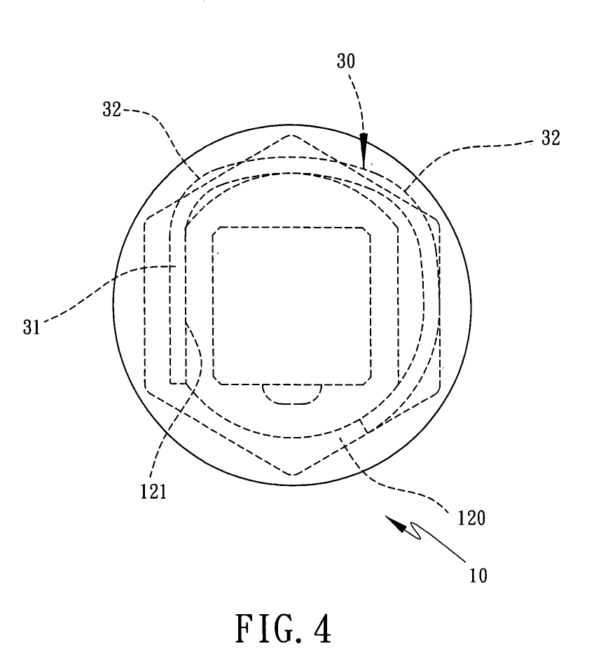

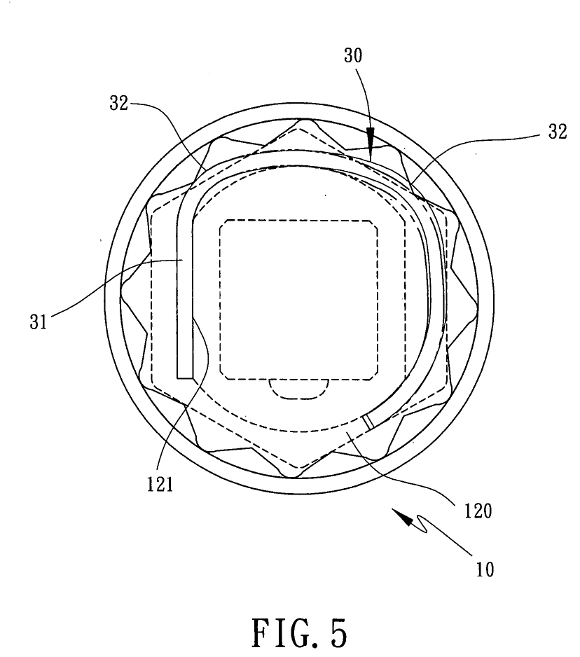

Referring to FIGS. 1 to 5, the positioning device of the present invention comprises a driving member 10 which is engaged with a polygonal inner periphery of a hole in wrench head 20 and includes a hexagonal driving protrusion 11 extending from one end of the driving member 10. An engaging portion 12 is connected to the driving protrusion 11 and located at the other end of the driving member 10. The engaging portion 12 has a groove 120 defined in an outer periphery thereof. An inner periphery defining the groove 120 includes a positioning part 121 which is a straight and flat surface.

A substantially C-shaped clip 30 is engaged with the groove 120 and has an engaging section 31 which is a straight section and matched with the positioning part 121 of the groove 120. The engagement between the engaging section 31 and the positioning part 121 is a non-circular engagement. The positioning part 121 is parallel to one of six sides of a driving protrusion 11 extending from one end of the driving member 10, such that the clip 30 does not rotate in the groove 120. The clip 30 has two biasing portions 32 which are two curves portions and extend out from the groove 120 so as to be engaged with the multiple sides of the polygonal inner periphery of a hole in wrench head 20.

The engagement between the clip 30 and the driving member 10 effectively prevents any relative movement therebetween so that the driving member 10 can be conveniently combined with the wrench head 20.

While we have shown and described the embodiment in accordance with the present invention, it should be clear to those skilled in the art that further embodiments may be made without departing from the scope of the present invention.

What is claimed is:

1. A positioning device for hand tools, comprising:
a driving member having a driving protrusion extending from an end thereof and an engaging portion located at the other end of the driving member, the engaging portion having a groove and an inner periphery defining the groove including at least one positioning part, and
a clip having at least one engaging section and at least one biasing portion.

2. The device as claimed in claim 1, wherein an engagement between the at least one engaging section and the at least one positioning part is a non-circular engagement.

3. The device as claimed in claim 1, wherein the at least one engaging section is parallel to one of six sides of a driving protrusion of the driving member.

4. A positioning device for hand tools, comprising:
a driving member having a groove and an inner periphery defining the groove including at least one positioning part, and
a clip having at least one engaging section and at least one biasing portion.

5. The device as claimed in claim 4, wherein an engagement between the at least one engaging section and the at least one positioning part is a non-circular engagement.

6. The device as claimed in claim 4, wherein the at least one engaging section is parallel to one of six sides of a driving protrusion of the driving member.

7. A positioning device for hand tools, comprising:
a driving member having a driving protrusion extending from an end thereof and an engaging portion located at the other end of the driving member, the engaging portion having a groove and an inner periphery defining the groove including at least one positioning part, and
a clip having at least one straight engaging section and at least one biasing portion.

8. The device as claimed in claim 7, wherein an engagement between the at least one engaging section and the at least one positioning part is a non-circular engagement.

9. The device as claimed in claim 7, wherein the at least one engaging section is parallel to one of six sides of a driving protrusion of the driving member.
